(19) United States
(12) Patent Application Publication
(10) Pub. No.: US 2009/0150536 A1
(43) Pub. Date: Jun. 11, 2009

(54) Application layer congestion control

(75) Inventors: Alastair Wolman, Seattle, WA (US); John Dunagan, Bellevue, WA (US); Johan Ake Fredrick Sundstrom, Kirkland, WA (US); Richard Austin Clawson, Sammamish, WA (US); David Pettersson Rickard, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/951,328

(22) Filed: Dec. 5, 2007

(51) Int. Cl. G06F 15/173

(52) U.S. Cl. 709/224

(57) ABSTRACT

A method of managing congestion within a request-response system is disclosed. The method includes determining a response time that is directly or indirectly indicative of how long it takes a back end system to process a request received from a front end system and return a corresponding response. The response time is compared to a threshold criterion. A determination is made, based at least in part on the comparison, that the back end system is becoming congested with requests from the front end system. The front end system is adjusted so as to at least temporarily reduce the number of requests provided to the back end system by the front end system.

### BACKGROUND

Request-response systems that use fixed timeout values are vulnerable to a “wasted work” problem in overload situations. This problem arises when a spike in the load on a server causes the processing time to exceed the timeout value. In this case, the work performed by the server is often wasted because the machine that generated the originating request will, in many cases, discard the response. Further, when timeouts occur and there is no throttling mechanism in place, systems typically respond to timeouts by reissuing the request (in case the request was lost at the network layer). This typically makes the situation worse, as the server ends up performing more and more wasted work.

The discussion above is merely provided for general background information and is not intended for use as an aid in determining the scope of the claimed subject matter.

### SUMMARY

Embodiments of systems and methods for managing congestion within a request-response system are disclosed. In one embodiment, a method includes determining a response time that is directly or indirectly indicative of how long it takes a back end system to process a request received from a front end system and return a corresponding response. The response time is compared to a threshold criterion. A determination is made, based at least in part on the comparison, that the back end system is becoming congested with requests from the front end system. The front end system is adjusted so as to at least temporarily reduce the number of requests provided to the back end system by the front end system.

This Summary is provided to introduce a selection of concepts in a simplified form that are further described below in the Detailed Description. This Summary is not intended to identify key features or essential features of the claimed subject matter, nor is it intended for use as an aid in determining the scope of the claimed subject matter. The claimed subject matter is not limited to implementations that solve any or all disadvantages noted in the background.

### BRIEF DESCRIPTION OF THE DRAWINGS

FIG. 1 is a schematic diagram of a request-response system.

FIG. 2 is a flow chart diagram demonstrating a series of steps carried out by front end components.

FIG. 3 is a table demonstrating an example of a graceful or algorithmic approach in the context of load shedding.

FIG. 4 is a table demonstrating one of many examples of how a request load adjustment component can be configured for load shifting through the adjustment of virtual instance settings based on response time data.

FIG. 5 is a schematic diagram of one example of a multiple back end system.

FIG. 6 illustrates an example of a computing system environment.

### DETAILED DESCRIPTION

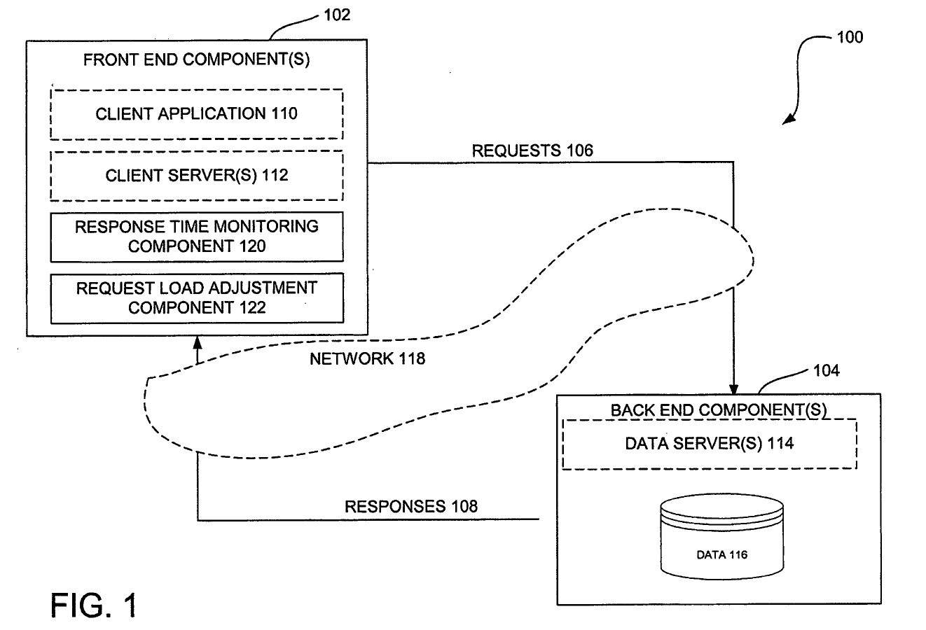

FIG. 1 is a schematic diagram of an example of a suitable request-response system 100 within which embodiments may be implemented. The system 100 is only one example of a suitable system and is not intended to suggest any limitation as to the scope of use or functionality of the claimed subject matter. Neither should the system 100 be interpreted as having any dependency or requirement relating to any one or combination of illustrated components. It should be noted that some components in system 100 are shown in dotted lines. The dotted lines are intended to indicate that the component might exist in a certain implementation but may not exist in every implementation. One particular example implementation that includes some or all of the dotted line components shown in FIG. 1 will be discussed in detail below.

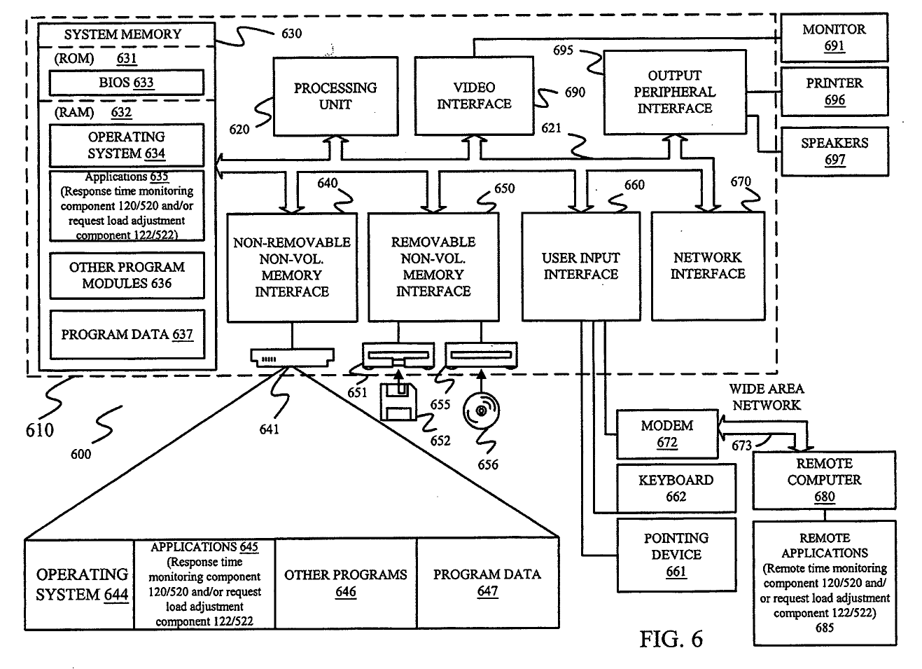

System 100 includes front end components 102 and back end components 104. In one embodiment, the front end 102 includes a computing device (e.g., device 610 shown in FIG. 6) configured to operate in a client capacity and back end 104 includes a computing device (e.g., device 610 shown in FIG. 6) configured to operate in a server capacity. Components 102 and 104 together implemented a request-response style protocol wherein the front end 102 issues requests 106 to back end 104. Back end 104 processes these requests and provides front end 102 with corresponding responses 108.

It should be noted that system 100 is not limited to being any particular type of request-response system. In one embodiment, system 100 is an Internet-oriented system configured to enable users to search through and navigate documents and other data published on the World Wide Web. In this case, front end components 102 are likely to include one or more client machines that operate a web browser application (illustratively shown in FIG. 1 as a client application 110). The web browser application facilitates user interaction functionality, including the generation of user requests. The front end also likely includes a web server (illustratively shown in FIG. 1 as a client server 112). The web server processes the user requests generated by the browser application and produces corresponding requests 106 that are submitted across the Internet (generically shown in FIG. 1 as network 118) to a data server 114 associated with backend 104. The data server illustratively processes the request 106 relative to a collection of data (shown as data 116) so as to generate a corresponding response 108. The response 108 is communicated across the Internet back to front end 102. The web server then facilitates the presentation of information related to the response 108 to the requesting user through the web browser application. Of course, this is a simplified example of a Web browsing system; those skilled in the art will appreciate that additional details have been left out for the purpose of providing an efficient and economical description of one exemplary implementation context.

Again, it is to be understood that system 100 is not limited to being any particular type of request-response system. In one embodiment, system 100 is an implementation of a simple database system. In another embodiment, the system is an implementation of an instant messaging system. In one embodiment, system 100 is but one portion of a multi-tiered request-response system that includes more than a single layer of request-response processing. In this case, the embodiments described herein can be implemented in some or all of the request-response processing layers.

For illustrative purposes, it will be assumed that system 100 is vulnerable to experiencing negative performance characteristics when back end 104 cannot effectively keep up with, for one reason or another, requests 106 from front end 102. This may be due to a sequence of events that create a “wasted work” scenario. In one embodiment of such a scenario, back end 104 is configured to impose a timeout restriction relative to its processing of requests 106. For example, backend 104 may be configured to process a single request for no more than a limited amount of time, the limited amount of time being a selectively imposed timeout value (e.g., a timeout value selected by a system administrator). Under the circumstances, back end 104 can become overwhelmed with requests when a spike in the request load causes the processing time to repeatedly exceed the timeout value.

A known cause for such a flood on back end 104 is that it is common for the back end to deliver an incomplete (or otherwise unsatisfactory) response 108 when the timeout value is exceeded. The work performed by the back end to generate the incomplete response 108 is wasted when, as is often the case, the front end is configured to discard the response. Then, it is a common scenario that front end 102 is configured to respond to a timeout by reissuing the same request 106 (e.g., in case the request was lost). Thus, when there is no throttling mechanism in place, the negative situation becomes progressively worse as back end 104 performs a steadily increasing amount of wasted work.

In one embodiment, front end 102 includes a response time monitoring component 120 and a request load adjustment component 122. Together, components 120 and 122 enable response time monitoring to be utilized as a basis for controlling the rate at which requests are issued by front end 102 to backend 104. In this manner, the request load can be managed in a variety of different ways. For example, in one embodiment, the request load is controlled so as to prevent or discourage back end 104 from experiencing a load that will cause processing times to reach the timeout value.

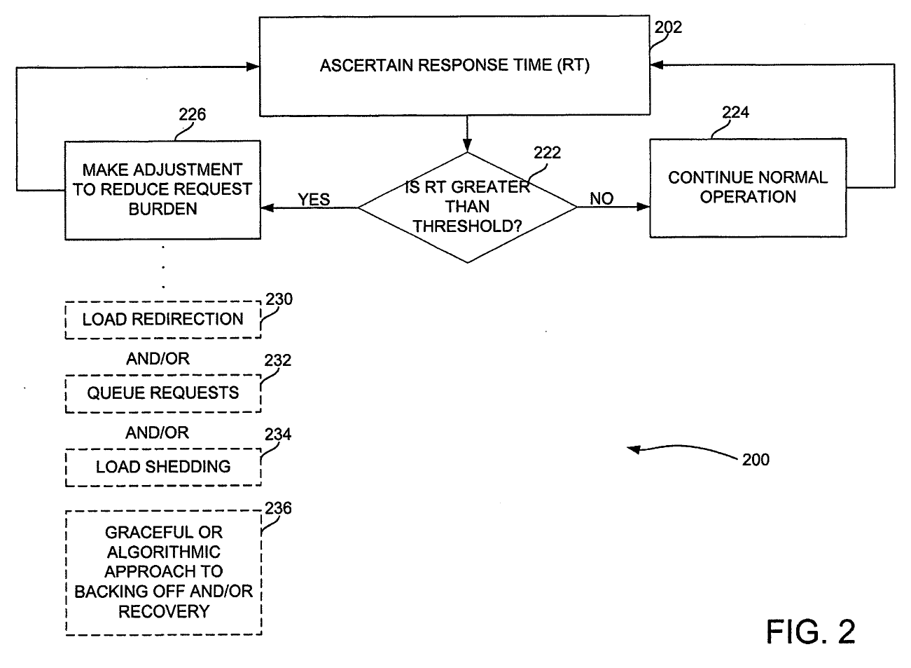

FIG. 2 is a flow chart diagram demonstrating one embodiment of a series of steps 200 carried out by front end components 120 and 122. In accordance with block 202, the amount of time that it takes back end 104 to provide a response 108 to a request 106 is determined. This step is illustratively performed by response time monitoring component 120. The other steps in process 200 are illustratively managed by request load adjustment component 122. In accordance with block 222 a determination is made as to whether the measure response time is greater than an established threshold (e.g., a threshold value selected by a system administrator). It should be noted that the threshold need not necessarily be as simple as a static response time value. For example, in one embodiment, the threshold can be a value in terms of rate of change (e.g., a detected rising pattern threshold reflected over a series of response times). Those skilled in the art will appreciate that other thresholds based on response time can be utilized without departing from the scope of the present invention.

In accordance with block 224, if the response time value is not greater than the threshold value, then front end 102 continues to issue requests 106 to back end 104 at a normal (e.g., unrestricted) rate. As is represented by the arrow leading out of box 224 and back into box 202, the response time is subsequently reevaluated. In one embodiment, the response time is evaluated for every request (i.e., block 222). In another embodiment, the response time is periodically evaluated (e.g., evaluated every x number of requests, evaluated after each passing of x amount of time, etc.).

In accordance with block 226, if the response time value is greater than the threshold value, then request load adjustment component 122 illustratively makes an adjustment so as to reduce the request burden on back end 104. Thus, component 122 is configured to enable front end 102 to respond on a short time scale to changes in load on backend 104. As is represented by the arrow leading out of box 226 and back into box 202, the response time is subsequently reevaluated. In one embodiment, the response time is evaluated for every request (i.e., block 222). In another embodiment, the response time is periodically evaluated (e.g., evaluated every x number of requests, evaluated after each passing of x amount of time, etc.).

In one embodiment, once component 122 has detected an increase of the response time value beyond the threshold value, there are different options for reducing the request burden on the back end. One option, represented by optional box 230, is for component 122 to manage the redirection (e.g., load redirection) of one or more requests 106 to an alternate back end (e.g., a different server) for processing and generation of a response 108. Another option, represented by optional box 232 is for component 122 to manage placement of some or all subsequent requests 106 into a queue (e.g., load caching) until component 120 indicates that back end 104 is sufficiently less busy, at which time the requests in the queue can be submitted. Another option, as is indicated by box 234, is for component 122 to manage the disposal of one or more requests 106 (e.g., load shedding). In this case, in one embodiment, component 122 is illustratively configured to present the user on the front end with some sort of error saying that the request was deleted because the back end was unusually busy. Depending on a given front end application context, any or all of options 230, 232 and 234 may be most appropriate. Those skilled in the art will appreciate that the options can be selectively implemented to accommodate a particular set of circumstances.

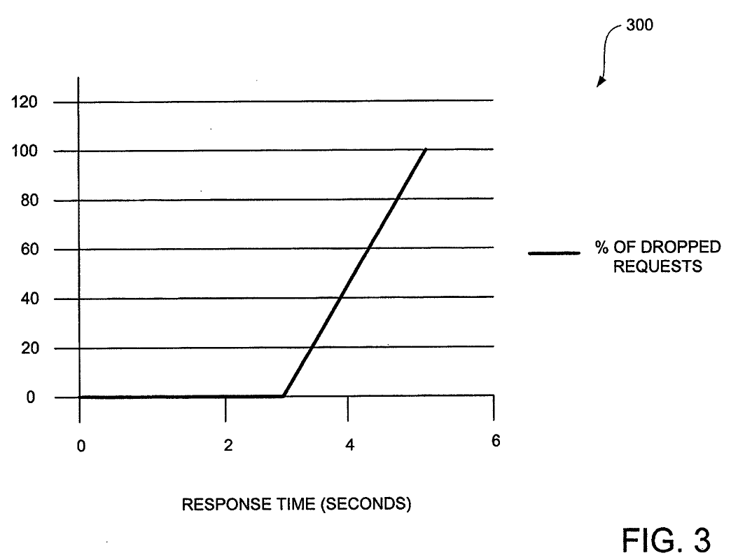

In one embodiment, in accordance with block 236, request load management component 122 is configured to implement a graceful or algorithmic approach to reducing the request load on the back end. FIG. 3 is a table 300 demonstrating an example of a graceful or algorithmic approach in the context of load shedding. In this case, component 122 is illustratively configured to drop no requests if the server response time is 3 seconds or less. However, once the response time exceeds the 3 second threshold, an increasing percentage of requests will be disposed of depending on how far the threshold is exceeded. If the response time exceeds five seconds, all requests will illustratively be disposed of. In one embodiment, as the response time decreases, the percentage of dropped requests will decrease as indicated until the response time goes below the 3 second threshold and requests are no longer being shed. There may be some advantages associated with the choice of 3 and 5 second thresholds at least in the context of a system that imposes a 5 second timeout. This is true because, in these circumstances, any request that takes more than 5 seconds would result in “wasted work,” and hence would be better off prevented. In general, if the goal of the algorithm is to prevent wasted work, the described graceful degradation is illustratively chosen as a function of the timeout value, so that the front end sends fewer requests as the response time approaches the time out value. That being said, it is to be understood, of course, that the values in table 300, including the 3 second threshold for beginning a load shedding process and the 5 second threshold for total request disposal, are exemplary only and can be adjusted as desired to accommodate a given set of circumstances, such as a particular front end application scenario.

Those skilled in the art will appreciate that request load adjustment component 122 can be configured to implement the same or similar algorithms in the context of load redirection and/or load queuing. Further, it is within the scope of the present invention for there to be transitions between load management methods. For example, the system may be configured to implement load redirection when the response time is between 3 and 3.5 seconds, then load queuing from 3.5 to 4 seconds, and then load shedding when the response time is above 4 seconds. Further, it is within the scope of the present invention for load management decisions to be based on factors other than time. For example, the system may be configured to redirect (or shed, etc.) the next 50 requests after the response time rises above a threshold value (then, the response time is reassessed). Those skilled in the art will appreciate that there are many options for load management and that the most appropriate option will require an application specific determination. Certainly the scope of the present invention is not limited to those specific options described herein.

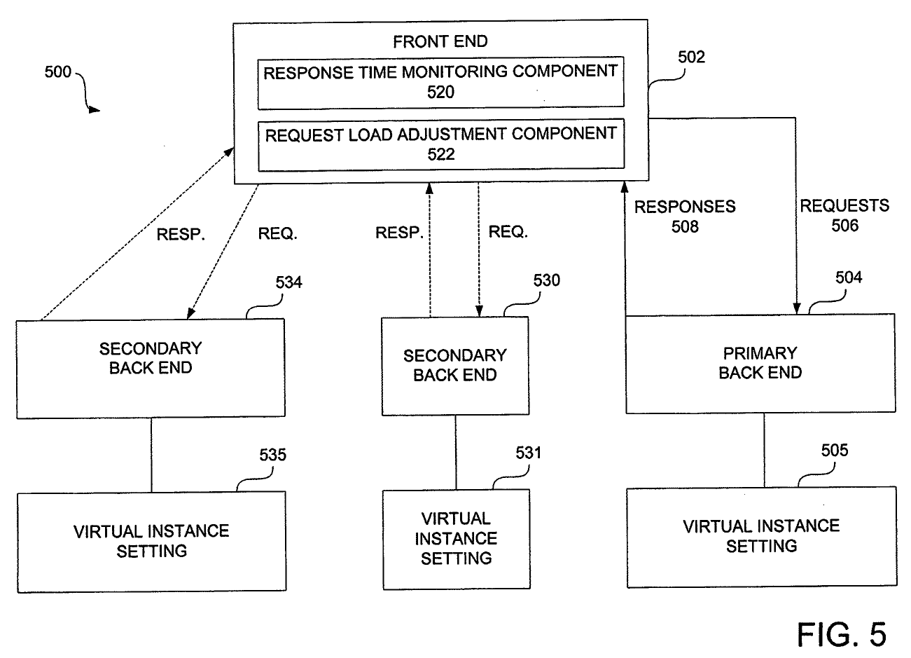

In one embodiment, a response time monitoring component and a request load adjustment component are configured to utilize response time data as a basis for managing server load across a plurality of backends. FIG. 5 is a schematic diagram of one example of a multiple back end system 500. Those skilled in the art will appreciate that system 500 is but one of many multiple back end environments within which embodiments of the present invention. System 500, which is, of course, a simplified depiction, includes a front end 502, a response time monitoring component 520 and a request load adjustment component 522 that are similar to corresponding components 102, 120 and 122 shown and described in relation to system 100 in FIG. 1.

System 500 also includes a primary back end 504, a first secondary back end 530, and a second secondary back end 534. Each of back ends 504, 530 and 534 is configured to receive requests 506 from front end 502, process the requests, and provide corresponding responses 508. In one embodiment, it is illustratively preferable for primary back end 504 to handle as many requests as possible (e.g., primary back end 504 might be configured to perform such processing the most efficiently).

Each back end includes a virtual instance setting, namely, virtual instance settings 505, 531 and 535. A virtual instance is illustratively a setting that serves as a metric (relative to the associated back end) indicative of capacity to accept and process requests. In one embodiment, settings 505, 531 and 535 are relative measures. For example, a back end with a setting of 10 virtual instances indicates a capacity to accept half as much load as a back end with a setting of 20 virtual instances.

Request load adjustment component 522 is illustratively configured to manage the request load distribution across back ends 504, 530 and 534 based on request response time values received from monitoring component 520 relative to one or more back ends. The goal is illustratively to avoid or discourage back end failure or overload.

In one embodiment, request load adjustment component 522 is provided with access to settings 505, 531 and 535. Component 522 is then configured to manipulate the settings as necessary to alleviate pressure from a back end or ends with high response times. For example, component 522 can reallocate the relative virtual instances values so as to re-focus the emphasis on where new requests are targeted. A back end with a high response time will illustratively be allocated fewer virtual instances. In one embodiment, the algorithm performs best when a back end's response time increases gradually before beginning to time out. In one embodiment, how close the response time is to timing out is utilized as a factor in determining how many virtual instances to allocate to the back end.

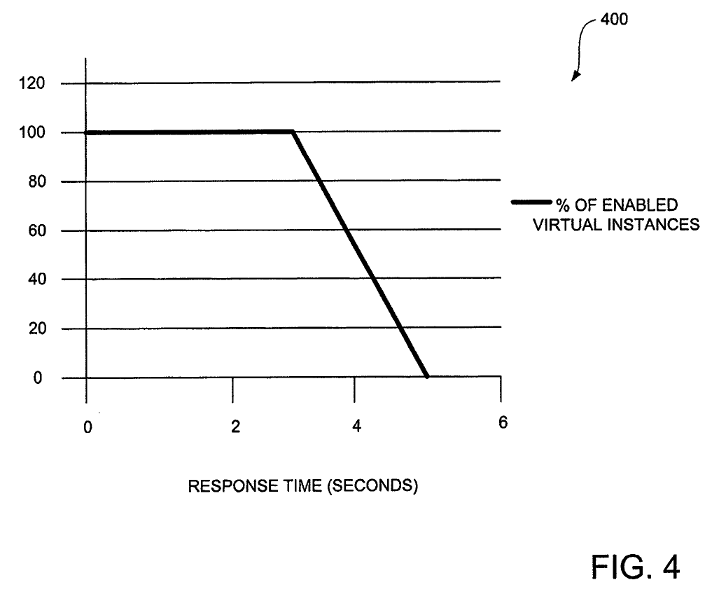

FIG. 4 is a table 400 demonstrating one of many examples of how request load adjustment component 522 can be configured for load shifting through the adjustment of virtual instance settings based on response time data received from component 520. In this case, no virtual instances are unallocated or disabled if the server response time is 3 seconds or less. However, once the response time exceeds the 3 second threshold, a decreasing percentage of virtual instances will remain active (or allocated) depending on how far the threshold is exceeded. If the response time exceeds 5 seconds, all virtual instances will be unallocated or deactivated. In one embodiment, as the response time decreases, the percentage of unallocated virtual instances will decrease as indicated until the response time goes below the 3 second threshold and all virtual instances are again enabled. It is to be understood, of course, that the values in table 400, including the 3 second threshold and the 5 second threshold, are exemplary only and can be adjusted as desired to accommodate a given set of circumstances, such as a particular front end application scenario. Utilizing a scheme such as that shown in FIG. 4, component 522 can at least partially decrease the number of virtual instances allocated to the primary back end by at least temporarily shifting the load to the secondary back ends 530 and 534 during busy primary back end periods. The load on the secondary back ends can be similarly monitored and maintained. Further, through implementation of the virtual node mechanism, disparate front ends are able to mostly redirect their requests to similar back ends, so that back ends are still able to cache relevant results. For example, if a request R1 is normally directed to back end B1, but both front end F1 and front end F2 notice that B1 is overloaded, they are likely to both redirect the request to the same alternative back end B2.

In one embodiment, if a back end times out on a call, it is at least temporarily flagged as out-of-service and given a high response time. Then all of its virtual instances are at least temporarily disabled.

In one embodiment, in addition to or instead of the described load shifting techniques, component 522 is configured to respond to a globally high load. In one embodiment, component 522 responds by dropping requests in order to prevent all requests from timing out and failing. Component 520 is illustratively configured to compute an average system-wide response time (i.e., accounting for each active back end). As the average response time across all servers increases, more requests are likely to begin to fail, though each individual back end might have different failure rates based on its individual response times. In one embodiment, requests are dropped and/or phased back in based on a global calculation. In one embodiment, component 522 is configured to drop requests in this manner utilizing a graceful or algorithmic approach, the same or similar to the approach illustrated in table 400 shown in FIG. 4.

Response time monitoring component 520 illustratively maintains a table that tracks response times for each back end. In one embodiment, these stored response times are exponentially weighted with a moving average that is moved toward 0 over time. This is to avoid the case where the response time is never updated because no calls are made to a particular backend because the time it too high. In one embodiment, out-of-service back ends are retired after a certain amount of time, because they are given a high response time after a timeout. In one embodiment, component 522 is configured to prevent or discourage back ends from failing but not necessarily (though it is conceivably possible) configured to balance load equally across all back ends. Of course, it should be emphasized that there are multiple policy options for when to decide that a back end is sufficiently congested such that future calls to it should be deferred (e.g., delayed, re-routed, shed, etc.).

Load redirection based on measurements of individual back ends and load shedding based on measurements of a plurality of back ends can be employed at the same time. For example, in one embodiment of this scenario, if the plurality of back ends as a whole is nearing its limit, the total amount of work in the system is appropriately throttled (preventing wasted work). Similarly, if one back end is nearing its limit, but most back ends are not, requests are redirected, preventing wasted work while simultaneously providing a better experience to clients in that their requests are serviced (not just dropped). In one embodiment, the system is configured such that the decision to drop a request takes precedence over the decision to redirect a request. In one embodiment, a dropped request is never redirected.

FIG. 6 illustrates an example of a suitable computing system environment 600 in which embodiments may be implemented. The computing system environment 600 is only one example of a suitable computing environment and is not intended to suggest any limitation as to the scope of use or functionality of the claimed subject matter. Neither should the computing environment 600 be interpreted as having any dependency or requirement relating to any one or combination of components illustrated in the exemplary operating environment 600.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments have been described herein in the general context of computer-executable instructions, such as program modules, being executed by a computer. Generally, program modules include routines, programs, objects, components, data structures, etc. that perform particular tasks or implement particular abstract data types. Embodiments can be practiced in distributed computing environments where tasks are performed by remote processing devices that are linked through a communications network. In a distributed computing environment, program modules can be located on both (or either) local and remote computer storage media including memory storage devices.

With reference to FIG. 6, an exemplary system for implementing some embodiments includes a general-purpose computing device in the form of a computer 610. Components of computer 610 may include, but are not limited to, a processing unit 620, a system memory 630, and a system bus 621 that couples various system components including the system memory to the processing unit 620.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637. Applications 635 are shown as including a response time monitoring component 120/520 and/or a request load adjustment component 122/522. This is but one example of a possible implementation.

The computer 610 may also include other removable/non-removable volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies. Applications 645 are shown as including a response time monitoring component 120/520 and/or a request load adjustment component 122/522. This is but one example of a possible implementation.

A user may enter commands and information into the computer 610 through input devices such as a keyboard 662 and a pointing device 661, such as a mouse, trackball or touch pad. Other input devices (not shown) may include a joystick, game pad, microphone, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. In addition to the monitor, computers may also include other peripheral output devices such as speakers 697 and printer 696, which may be connected through an output peripheral interface 695.

The computer 610 is operated in a networked environment using logical connections to one or more remote computers, such as a remote computer 680. The logical connection depicted in FIG. 6 is a wide area network (WAN) 673, but may also or instead include other networks. Computer 610 includes a modem 672 or other means for establishing communications over the WAN 673, such as the Internet. The modem 672, which may be internal or external, may be connected to the system bus 621 via the user-input interface 660, or other appropriate mechanism. Remote computer 680 is shown as operating remote applications 685. Applications 685 are shown as including a response time monitoring component 120/520 and/or a request load adjustment component 122/522. This is but one example of a possible implementation.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of managing congestion within a request-response system, the method comprising:
determining a response time that is directly or indirectly indicative of how long it takes a back end system to process a request received from a front end system and return a corresponding response;
comparing the response time to a threshold criterion;
determining, based at least in part on the comparison, that the back end system is becoming congested with requests from the front end system; and
adjusting the front end system so as to at least temporarily reduce the number of requests provided to the back end system by the front end system.

2. The method of claim 1, wherein comparing the response time to a threshold criterion comprises comparing the response time to a timeout value associated with the front end system.

3. The method of claim 1, wherein adjusting the front end system comprises redirecting requests from the front end system to a different back end system.

4. The method of claim 3, wherein the amount of requests that are redirected varies depending upon the response time.

5. The method of claim 3, wherein requests are redirected so that the front end and at least one additional different front end redirect the majority of their requests to the different back end system.

6. The method of claim 1, wherein adjusting the front end system comprises delaying transmission of one or more requests from the front end system to the back end system.

7. The method of claim 6, wherein the amount of requests that are delayed varies depending upon the response time.

8. The method of claim 1, wherein adjusting the front end system comprises shedding one or more requests.

9. The method of claim 8, wherein the amount of requests that are shed varies depending upon the response time.

10. The method of claim 8, wherein shedding one or more requests comprises providing a user with an error indicating that a response to a request should not be expected.

11. The method of claim 1, wherein determining a response time comprises determining a response time that is directly or indirectly indicative of how long it takes a plurality of back end systems to process a request received from a front end system and return a corresponding response.

12. The method of claim 11, wherein determining a response time that is directly or indirectly indicative of how long it takes a plurality of back end systems to process a request comprises determining a response time across the plurality of back end systems in combination.

13. The method of claim 11, wherein determining a response time comprises determining a response time that is an aggregate function of response times of the individual back end systems that collectively comprise the plurality of backend systems.

14. A computer-implemented system for managing request-response congestion, the system comprising:
a response time monitoring component that determines a response time that is directly or indirectly indicative of how long it takes a back end system to process a request received from a front end system and return a corresponding response;
one or more request load adjustment components that compare the response time to a threshold criterion and determine, based at least in part on the comparison, that the back end system is becoming congested with requests from the front end system, the one or more request load adjustment components being further configured to adjust the front end system so as to at least temporarily reduce the number of requests provided to the back end system by the front end system.

15. The system of claim 14, wherein the threshold criterion is a timeout value associated with the front end system (102, 502).

16. The system of claim 14, wherein the request load adjustment component sheds requests based on a measured response time across the plurality of back end systems, and wherein the request load adjustment component also redirects requests from the front end system to a different back end system based on the response time of the particular back end system.

17. The system of claim 14, wherein the request load adjustment component redirects transmission of one or more requests such that disparate front ends, including the front end system, redirect to similar back ends.

18. The system of claim 14, the request load adjustment component (122, 522) sheds (234) one or more requests (106, 506) based on the response time.

19. A computer-implemented request load adjustment component (122, 522) that adjusts (226) a front end system (102, 502) so as to at least temporarily reduce the number of requests (106, 506) provided to the back end system (104, 504) by the front end system (102, 502), wherein the nature of the adjustments to the front end system (102, 502) varies depending upon the time that it takes the back end system (104, 504) to process a request (106, 506) received from the front end system (102, 502) and return a corresponding response (108, 508).

20. The request load adjustment component of claim 19, wherein the component (122, 522) is configured to dispose of one or more requests (106, 506).
